(19) United States
(12) Patent Application Publication
(10) Pub. No.: US 2016/0379302 A9
(43) Pub. Date: Dec. 29, 2016

(54) SYSTEM AND METHOD FOR PREPARATION OF CLINICAL TRIAL BUDGETS

(71) Applicant: Tracy H. BLUMENFELD, Philadelphia, PA (US)

(72) Inventor: Tracy H. BLUMENFELD, Philadelphia, PA (US)

(21) Appl. No.: 14/621,100

(22) Filed: Feb. 12, 2015

Related U.S. Application Data
(63) Continuation of application No. 14/075,549, filed on Nov. 8, 2013.
Application No. 14/075,549 is a continuation of application No. 10/118,369, filed on Apr. 9, 2002, now Pat. No. 8,620,677.

(51) Int. Cl. G06Q 40/00; G06Q 50/22; G06F 19/00; G06Q 20/14

(52) U.S. Cl. CPC G06Q 40/00; G06Q 20/145; G06Q 50/22; G06F 19/366

(57) ABSTRACT

Medical and other research organizations, sites within those organizations, and physicians practicing at those sites register in an online database. The company providing the database posts a description of a clinical trial opportunity or other research opportunity. The company can search and match for physicians with research opportunities, or the physicians can browse the list of opportunities. Once it is determined who will perform the research and awarded a contract, performance data are collected at 30-day intervals over the life of the trial for computation of benchmarks. The benchmarks from one physician are compared anonymously to those from other physicians participating in the same opportunity.

### REFERENCE TO RELATED APPLICATION

The present application is a continuation of U.S. patent application Ser. No. 10/118,369, filed Apr. 9, 2002, whose disclosure is hereby incorporated by reference in its entirety into the present disclosure.

### FIELD OF THE INVENTION

The present invention is directed to a system and method for evaluation of the performance and progress of research trials and more specifically to such a system and method, which provide benchmark metrics in real time.

### DESCRIPTION OF RELATED ART

In clinical trials for pharmaceuticals and the like, data must be taken over an extended period. For example, at intervals of time, typically 30 days, data must be taken on the number of patients who are participating in the trial, the number who have dropped out, the queries per patient, and the like.

However, the data are typically collected and tabulated by pharmaceutical companies to manage their project timelines. Such information is rarely shared with the physicians and health-care professionals conducting the research studies for purposes of understanding how they are performing, how other research sites are doing and/or learning from other clinicians participating in the study about how to improve their study management and performance. Currently no electronic mechanism exists that systematically, and automatically provides clinicians the ability to interact with the physicians and health-care professionals conducting the research studies for purposes of understanding how they are performing, how other research sites are doing and or learning from other clinicians participating in the study about how to improve their study management and performance. Currently no electronic mechanism exists that systematically and automatically provides clinicians and/or pharmaceutical sponsors with the ability to obtain interactive, real-time benchmarks and with those benchmarks better assess physician capabilities for matching physicians and research sites and with those data better assess physician capabilities for matching physicians and research sites for future clinical trials.

One Internet-based technique for matching experts in the biological sciences with those needing their services is disclosed in WO 01/29708, published Apr. 26, 2001. That technique provides for matching based on qualifications and times of availability as well as payment. However, once the experts and their customers are matched, there is no evaluation of the work, which the former do for the latter.

### SUMMARY AND OBJECTS OF THE INVENTION

It will be readily apparent from the above that a need exists in the art for an online, interactive evaluation of research performance. It is therefore a primary object of the invention to collect data concerning the progress of research and to provide an evaluation based on the collected data.

It is another object of the invention to provide an interactive, automated, online technique for doing so.

It is a further object of the invention to provide such an evaluation based on data collected at various time intervals.

It is a still further object of the invention to allow comparative evaluations among various trials.

It is a still further object of the invention to allow comparative evaluations without divulging the identity of one trial to researchers participating in another.

To achieve the above and other objects, the present invention is directed to an online, automated technique for collecting data not only for clinical trials but for other types of medical research including: marketing research, outcomes studies, disease management, etc. This type of medical research information would be information used to support the post approval product launches, marketing, product positioning, business development opportunities including licensing from clinical trials at intervals of e.g., 30 days and for performing automated, online evaluations based on the data. The evaluations can be presented in textual or graphical formats. A common server can be used to collect data from multiple trials, with the appropriate protection of the data from each trial for privacy purposes. The comparisons, e.g., for cost per patient, can be presented anonymously; for example, the figures for the highest and lowest costs per patient can be given without identifying the sources for those figures.

Users register for the service as organizations. The system will then ask the user to register all sites and physicians that fall under the umbrella of the organization. If a physician is a solo practitioner, the physician still must complete all three profiles, although some information may be duplicated, since each profile focuses on collecting differing information. During the registration process, each user provides information to be entered into a database. For a physician, the information concerns the physician's own practice and the site, if any, at which the physician is an administrator. For a site, the information concerns such things as the facilities at the site and the physicians practicing at the site. For an organization, the information concerns such things as the type of organization and the sites and physicians within the organization.

A listing of a clinical trial opportunity (blinded synopsis) or other research opportunity (blinded synopsis) with an accompanying protocol synopsis specific questionnaire (SQQ) is posted on the website. The listing is categorized to allow browsing by prospective researchers who are members. In addition, the service can search the database to find suitable physicians, sites or organizations who preliminarily match the criteria the sponsor has provided to the service and then select which ones are to be contacted about the clinical trial opportunity. That occurs by cross-referencing project requirements with general information about the sites, physicians and organizations. Contacting members about opportunities occurs via e-mail or facsimile to invite them to consider the opportunity. Following the researchers' completion of any new data not currently in the database and contained in the SQQ, the research electronically submits the completed SQQ via email to the service. The service summarizes all the information across all completed SQQ's for the specific research opportunity and forwards qualified and matched researchers to the sponsor. The sponsor then selects which research provided by the service they will select for the clinical trial.

Once a researcher is selected for the study, information about the study is entered into the database, e.g., at the beginning and end of the study and at 30-day intervals or less therebetween. The information concerns such things as the number of patients who have signed up and the number who have dropped out. Thus, benchmarks can be computed over time.

Study (clinical trial/protocol) specific benchmarks from one researcher, site and or organization can be anonymously compared with those from other researchers, sites and/or organizations. In one example of a comparison, four values of a benchmark are given: the highest and lowest values from the researcher, site and organization participating in the study, the median from all researchers, sites and/or organizations, and the actual value from the researcher, site and/or organization with which the person viewing the results is linked in which the person viewing the results is participating. The identities of the other researchers, sites and/or organizations from which the information is provided are not given, thus preserving confidentiality. The user can thus see how their researcher, site and or organization performance results for the study compares with other researcher, site and/or organization performance results for the study and can use that information, e.g., to see where efficiency can be improved, budgets should be reallocated, patients that qualify for the study can be found, training is required or to make the case for an increase in the research budget.

### BRIEF DESCRIPTION OF THE DRAWINGS

A preferred embodiment of the present invention will be set forth in detail with reference to the drawings, in which:

FIG. 1 shows a hardware architecture on which the preferred embodiment can be implemented;

FIGS. 2, 2A-21, 3, 3A-3D, 4 and 4A-4C show flow charts and screen shots of the registration and data inputting process for new users;

FIGS. 5A and 5B show a physician registration page;

FIG. 6 shows a search page;

FIG. 7 shows a search result page;

FIG. 8 shows a flow chart of the processes involved in posting a CTO or ORO description;

FIGS. 8A-8E show screen shots of the processes of FIG. 8;

FIG. 9 shows a merge page;

FIGS. 10 and 11 show pages used in collecting progress data;

FIGS. 12 and 13 show pages used in displaying benchmark data; and

FIG. 14 shows a flow chart of operation of an enhancement to the service which allows physicians to obtain information on fees.

### DETAILED DESCRIPTION OF THE PREFERRED EMBODIMENT

A preferred embodiment of the present invention will now be set forth in detail with reference to the drawings, in which like reference numerals refer to like elements or process steps throughout.

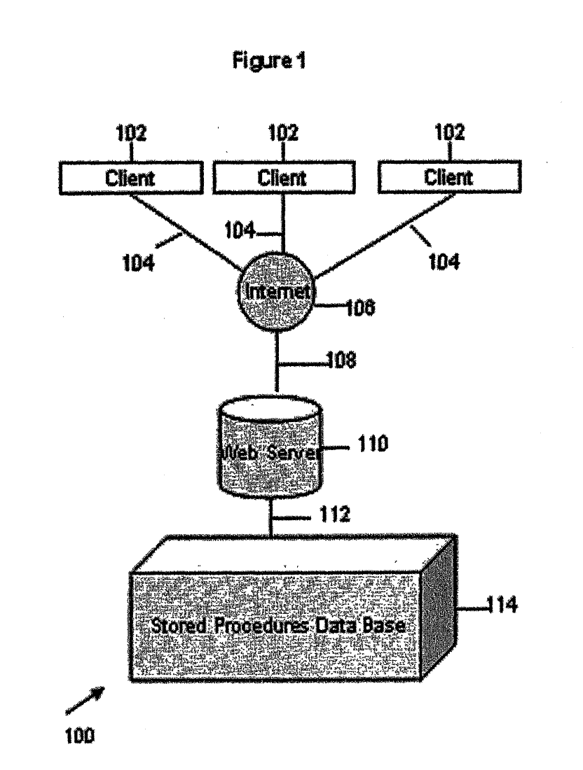

FIG. 1 shows an example of a hardware architecture on which the preferred embodiment can be implemented. The design of the hardware architecture has been selected to follow the industry-standard N-tier architecture, separating site navigation and design from stored procedures and data. In that way, one part of the site can be redesigned without breaking another part of the site. For instance, the HTML which provides the user interface can be changed without affecting the stored procedures and tables of the database.

FIG. 1 shows such a hardware architecture 100. Client devices 102, which can be microcomputers or any other devices capable of communicating over the Internet, connect via any suitable connections 104, such as dial-up or cable modem connections, to the Internet 106, and thence via a full-time Internet connection 108 to a Web server 110. The client devices are used by physicians, research sponsors, research sites such as hospitals, and others participating in the operations of the preferred embodiment. The Web server 110 provides business services, such as site navigation and design, and is connected via a full-time dedicated connection 112 to a database server 114 storing the stored procedures and database tables. Thus, the client devices 102 access the stored procedures and database tables in the database server 114 only through the Web server 110. It is preferable to implement the Web server 110 and the database server 114 on separate, dedicated machines to facilitate backups and restarts with a minimum of disruption. The Web server 110 implements interactive HTML pages through known technologies, such as CGI or ASP.

The database stored in the database server 114 is populated when physicians and organizations register and provide the information required for registration. As is known in the art, the Web server 110 provides persons accessing it from client devices 102 with several options, including physician registration and organization registration.

A user registers as an organization; physician registration and site registration are part of organizational registration. As noted above, a solo practitioner still registers as an organization. The organizational registration has two parts, the first part resulting in temporary status and the second part resulting in active status.

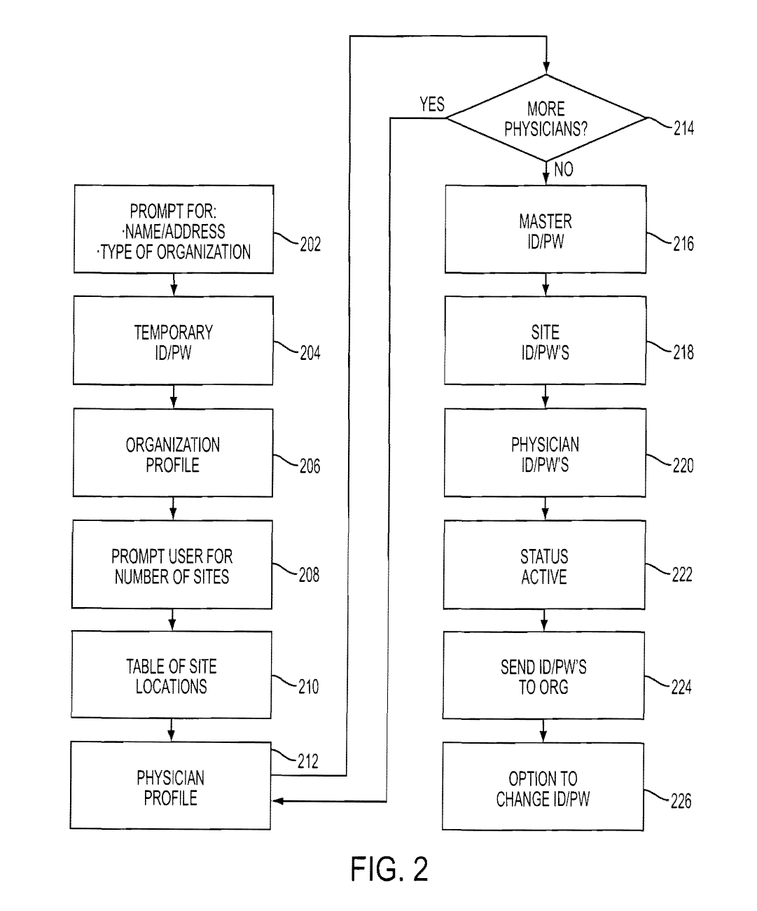

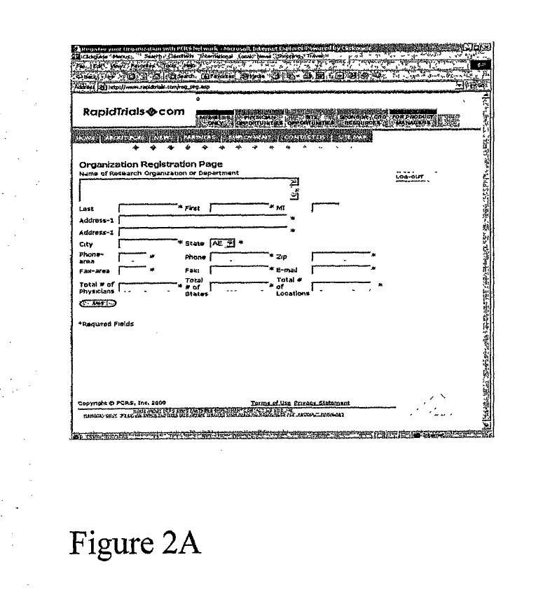

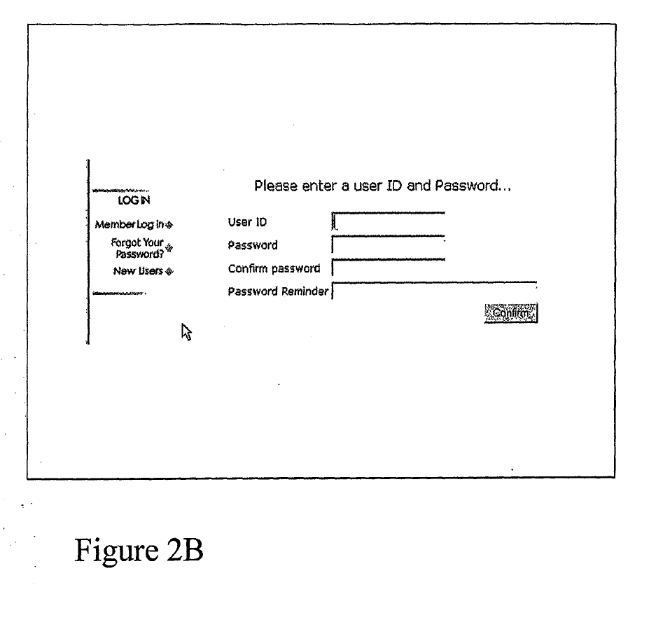

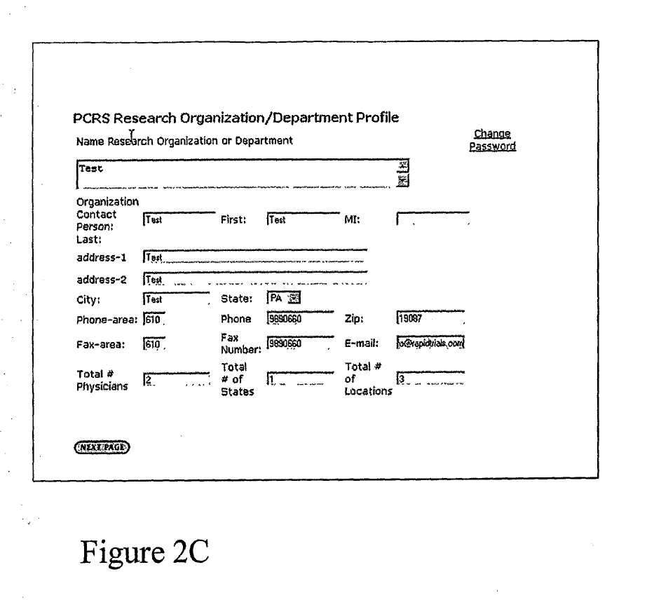

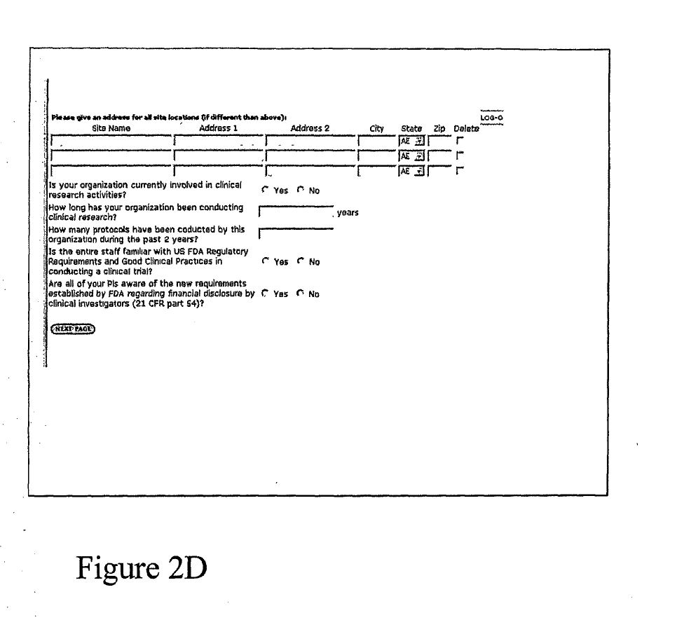

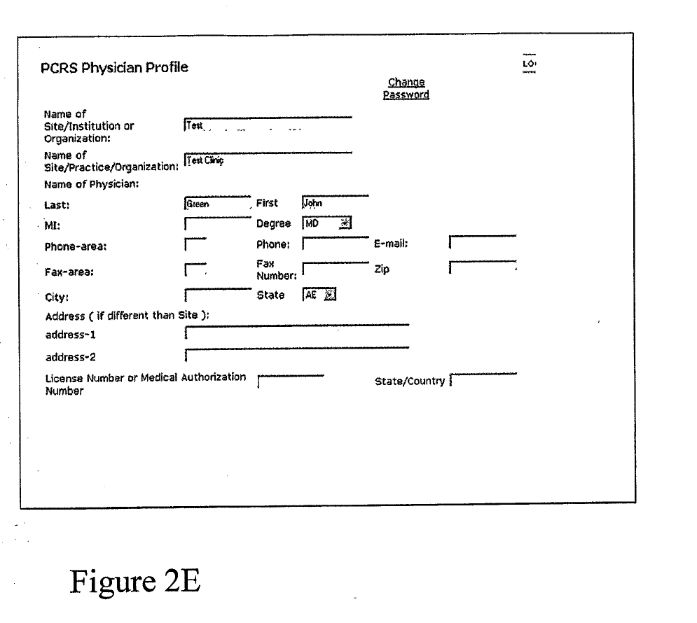

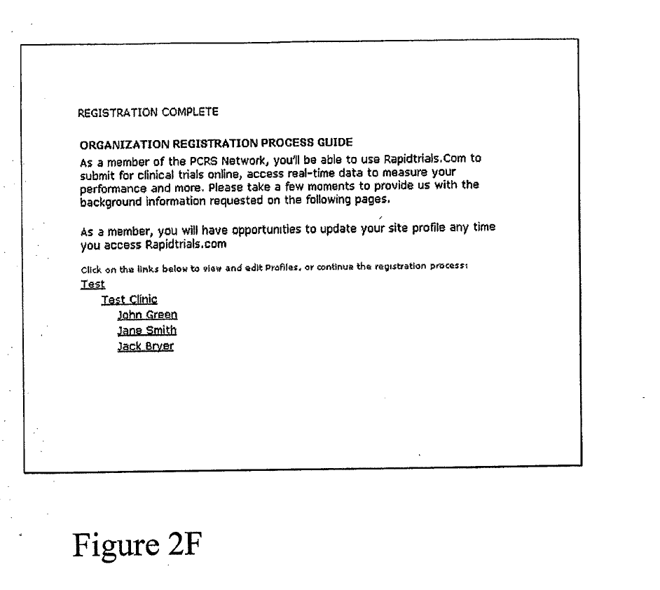

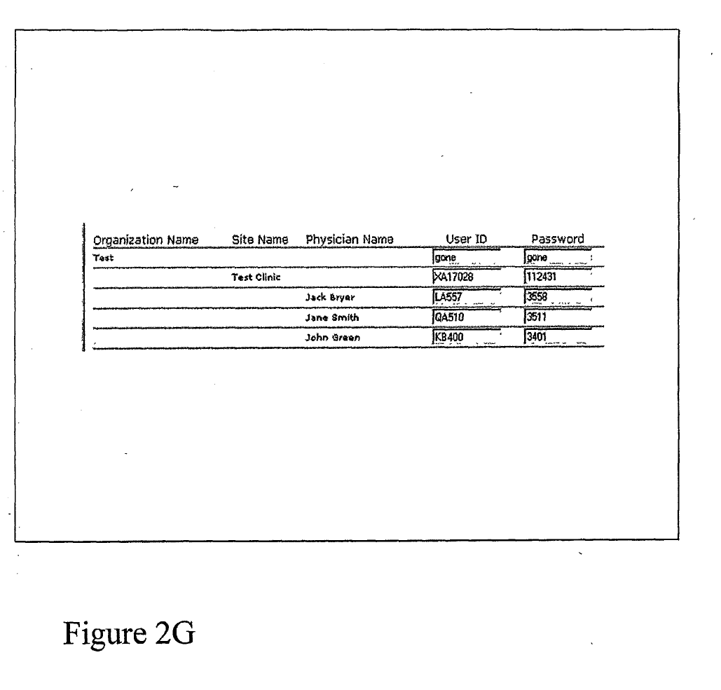

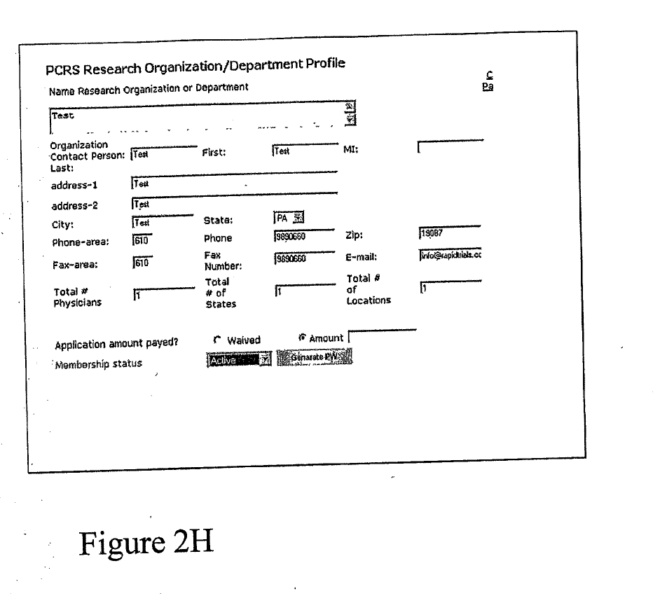

FIG. 2 shows an overview of organization registration. At step 202, the user is prompted for the name and address of the organization and for the type of organization (see the Web page of FIG. 2A). The latter is preferably selected through check boxes, so that multiple choices may be selected, although it may be selected through a drop-down menu or radio buttons if only one choice is allowed. At step 204, once that information is received, a temporary user identification and password are generated and provided to the user (or the user can select them; see FIG. 2B). The user is then allowed to view more detailed descriptions of the research opportunities; however, if any particular opportunity is selected, the user must proceed to the second part of the registration.

That second part begins at step 206, in which the user is prompted to complete an organizational profile (see FIG. 2C). When the User is completing the site location section of the organization profile, the first page of the organization profile asks “how many site locations” at step 208, and this automatically generates, at step 210, a table (see FIG. 2D) on page two of the organization profile with the necessary number of rows for all site locations. The User must complete this table in order to advance to page three of the organization profile; that will generate the correct number of site profiles. At step 212, the user completes a physician profile (see FIG. 2E) for each physician within the organization, until it is determined at step 214 (see FIG. 2F) that profiles have been completed for all physicians within the organization; step 214 can be performed like step 210. Identifications and passwords are generated for the organization as a whole, for each site, and for each physician at steps 216, 218 and 220, respectively (see FIG. 2G). At step 222, it is indicated in the database that the organization's status is that of an active member (see FIG. 2H). At step 224, the identifications and passwords are sent to the organization. At step 226, a responsible person at the organization has the option to change the identification and password for the organization (see FIG. 2I). The organization representative has the ability to change any data about the organization, sites or physicians and has complete access to all three profiles. The representative cannot add further sites or physicians or edit the name of a physician.

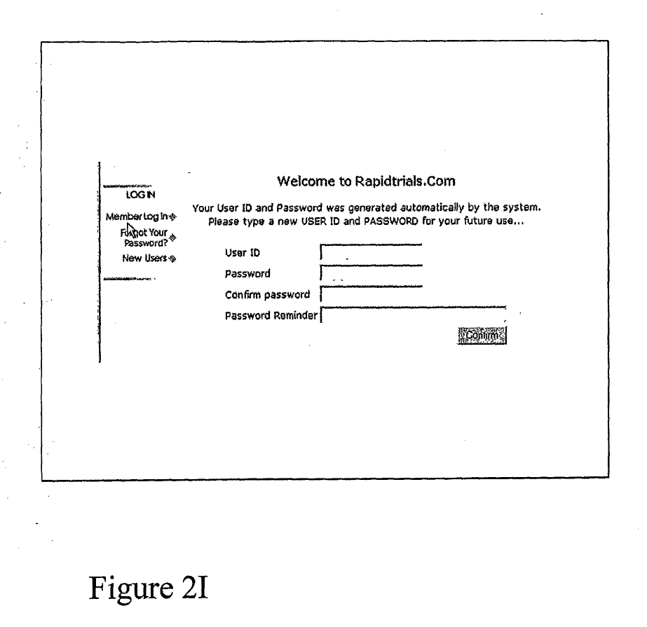

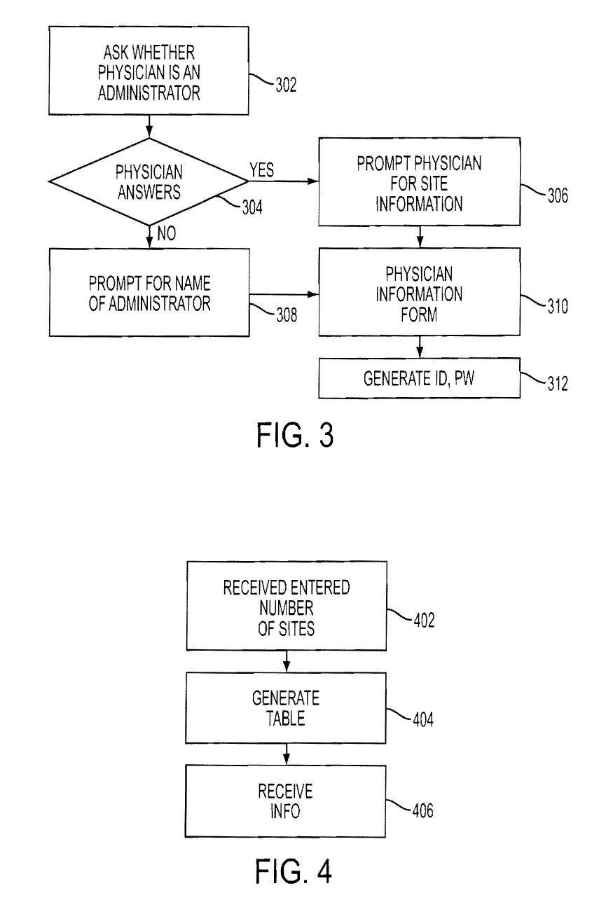

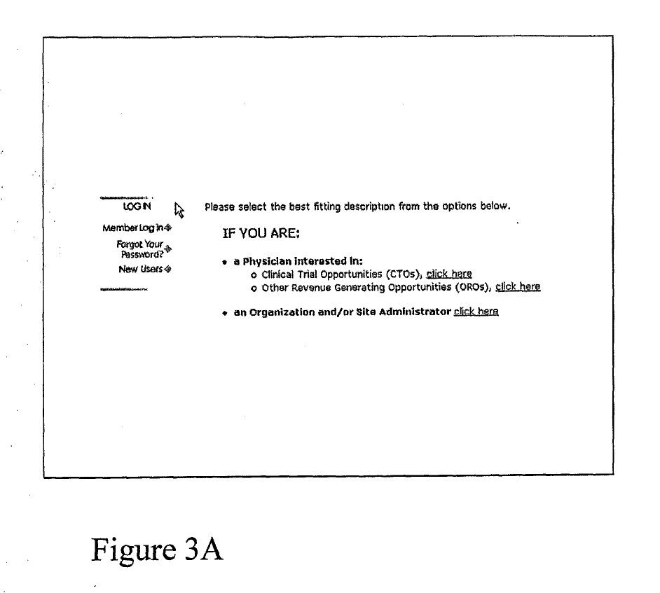

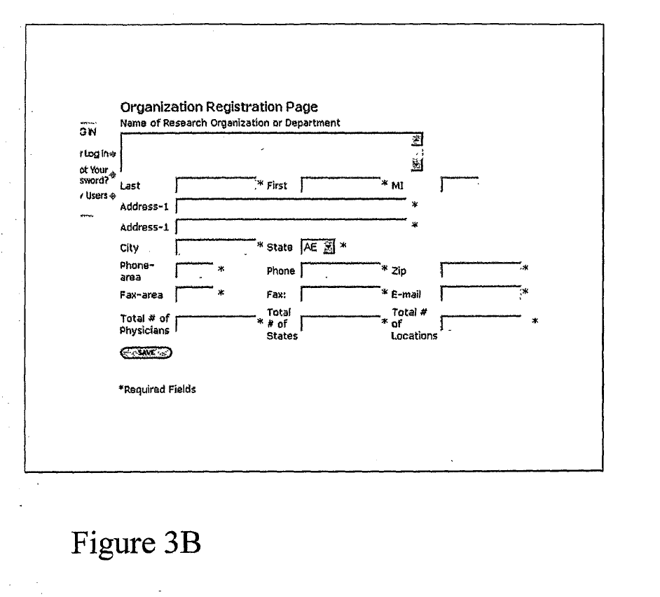

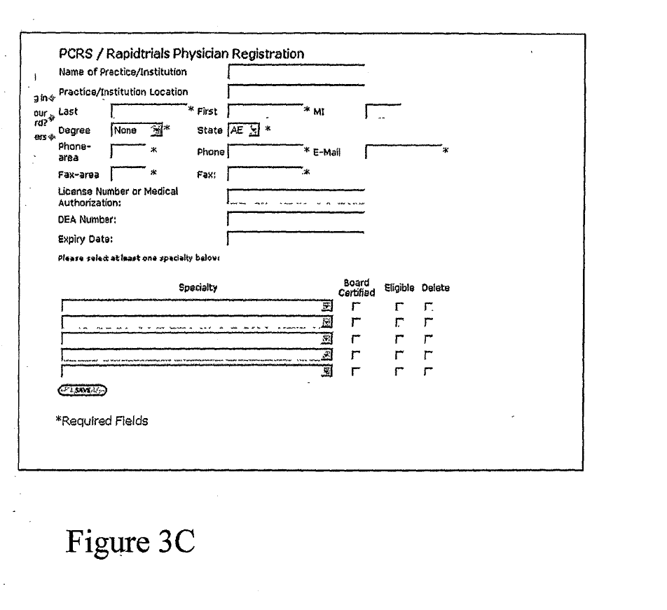

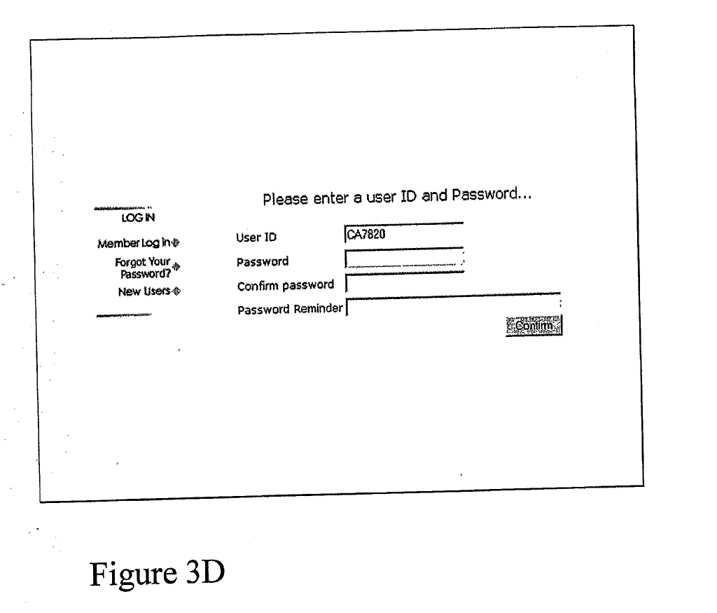

FIG. 3 shows an overview of the physician registration process of step 212. At step 302 (see FIG. 3A), the Web server asks whether the physician is an administrator at the site at which the physician works. If it is determined at step 304 that the physician has answered in the affirmative, the physician is prompted at step 306 (see FIG. 3B) for information about the site, in a manner which will be described in detail below. If not, the physician is prompted at step 308 for the name of an administrator at that site. Either way, the physician's information is taken in a physician information form at step 310 (see FIG. 3C). A user identification (ID) and password (PW) are generated for the physician at step 312 (see FIG. 3D).

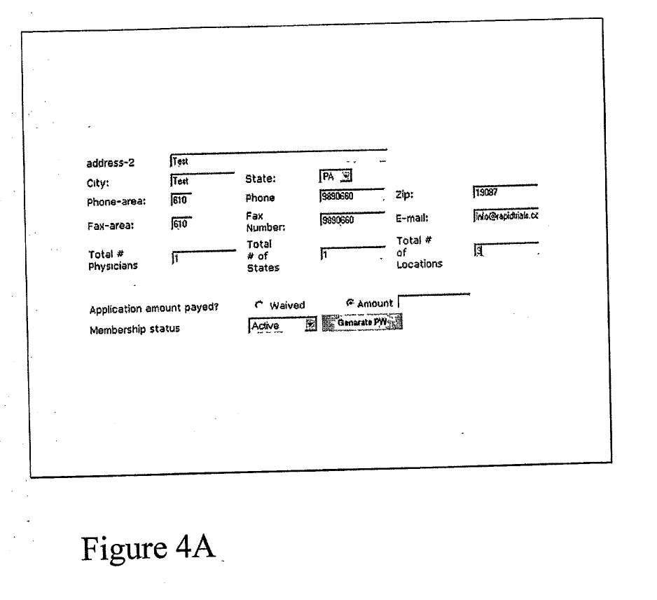

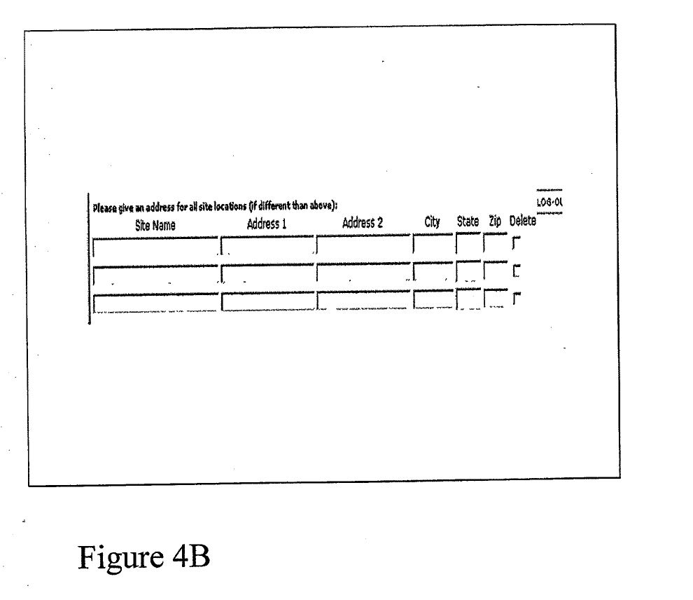

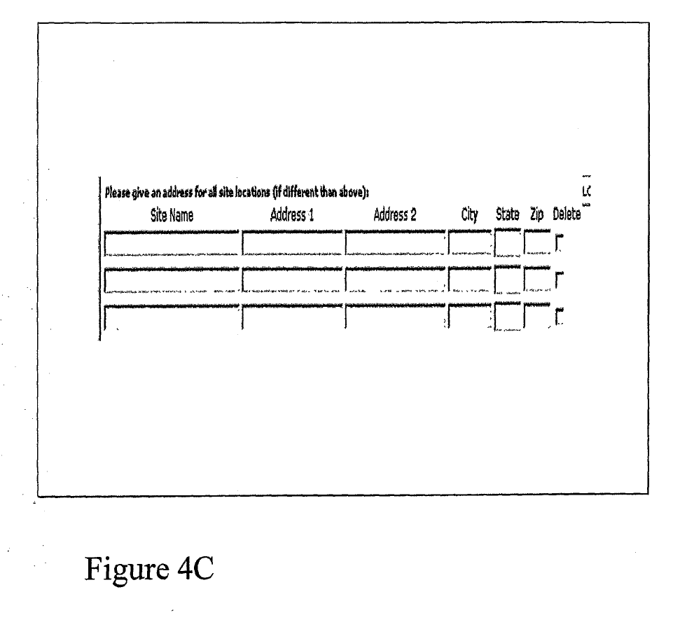

FIG. 4 shows an overview of the site registration of step 210. The number of sites input by the user is received at step 402 (see FIG. 4A). As noted above, a table of site locations, having a sufficient number of rows, is generated at step 404 (see FIG. 4B). The user completes the table, including information for each site, at step 406 (see FIG. 4C).

The data entry forms will now be described. In general, a data entry form can be implemented in HTML as one page or several; if it is implemented in several pages, each page ends with “Next Page” (or if the last page of the form “Submit”), “Discard Changes and Exit” or “Save Changes and Exit” options. Also, the same forms can be used to add information about new users and to update information for existing users.

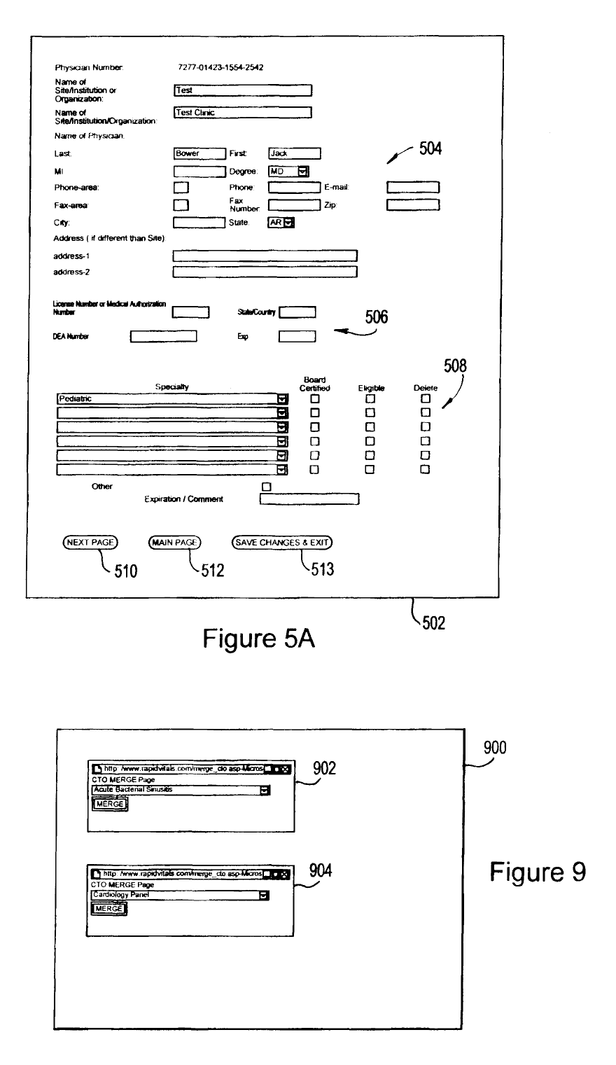

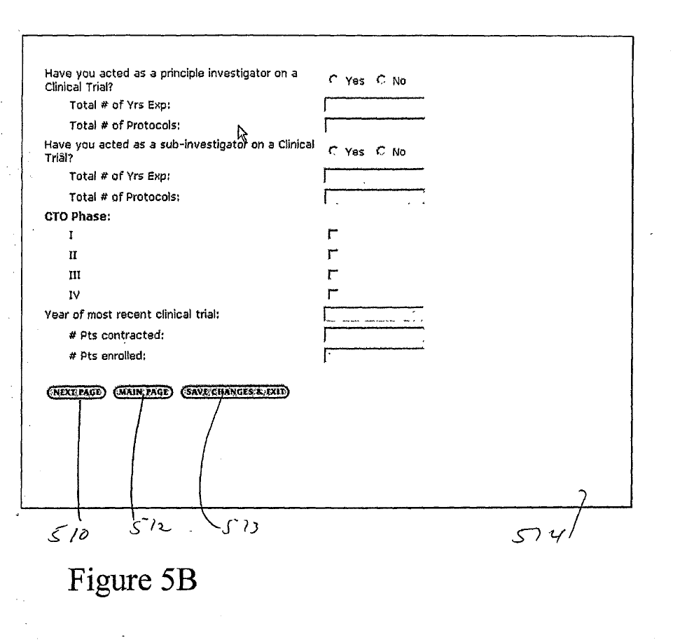

FIG. 5A shows the first page of the physician's form. The first page 502 includes an area 504 for contact information, an area 506 for medical licensing and DEA information, and an area 508 in which the physician can identify specialties through drop-down menus. Other information, such as professional affiliations with one or more medical schools and hospitals, can be solicited here. There are also “Next Page” (or if the last page of the form “Submit”), “Main Page” and “Save Changes and Exit” buttons 510, 512 and 513, as mentioned above.

FIG. 5B shows a subsequent page 514 of the physician's form. As shown in FIG. 5B, the physician is asked about experience as a principal investigator in a clinical trial. Detailed experience on each clinical trial can be solicited in further pages, as well as information on any FDA or sponsor audit that the physician or the site has undergone, any administrative roles that the physician plays at the site, any articles or presentations in which the physician is named as an author, and any organizations and associations in which the physician is actively involved.

The pages requesting organization and site information are similar. In addition, the organization pages request the type of organization, while the site pages request what facilities the site has, among other things. Pages can also be provided to transfer a physician from one site or organization to another or to transfer a site from one organization to another. This function is accessible solely to employees of the service, not registered users.

The administrator of the database server 114 can accept the information as given or can take various steps to verify it. For example, the administrator can verify that a given facsimile number or e-mail address words, check a given medical license number, or interview either the person submitting the information or those persons named as references.

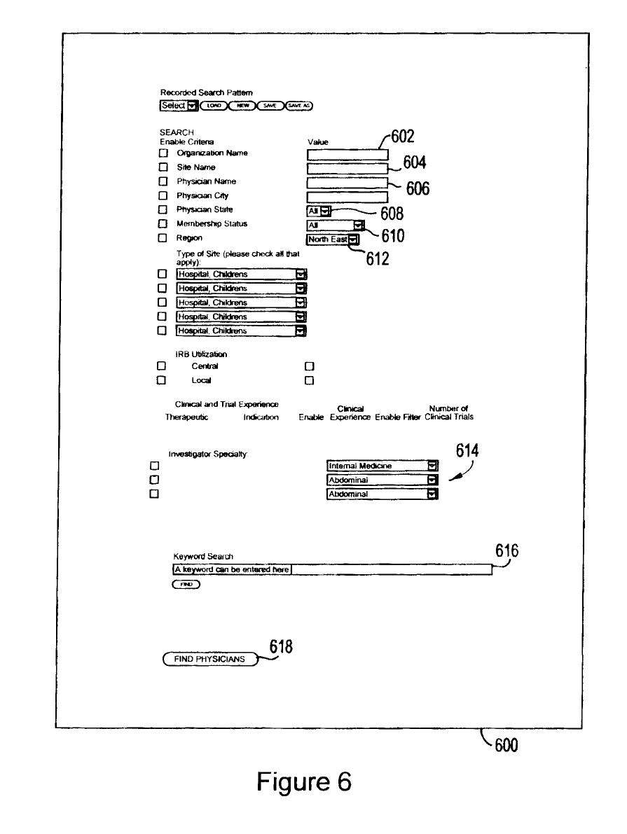

Once all of the data concerning participating physicians, organizations, and sites have been entered into the database, the database can be searched. FIG. 6 shows a search page for searching for physicians. The search page 600 uses text boxes and drop-down menus, although other suitable interface elements can be used as needed. In any text box, wildcard searching can be allowed.

Physicians can be searched by name, site, organization, or any combination of the three by use of the text boxes 602, 604, 606. The drop-down menu 608 allows the search to be conducted for physicians who are members, non-members, or either. The person conducting the search can select a state through a drop-down menu 610 or a region through a drop-down menu 612. A specialty can be selected through a drop-down menu 614. Key words can be entered in a text box 616. The page 600 can be designed to include any other search criteria, such as those relating to clinical trial experience. Once all of the search criteria are entered, the user clicks on the “Find Physicians” button 618.

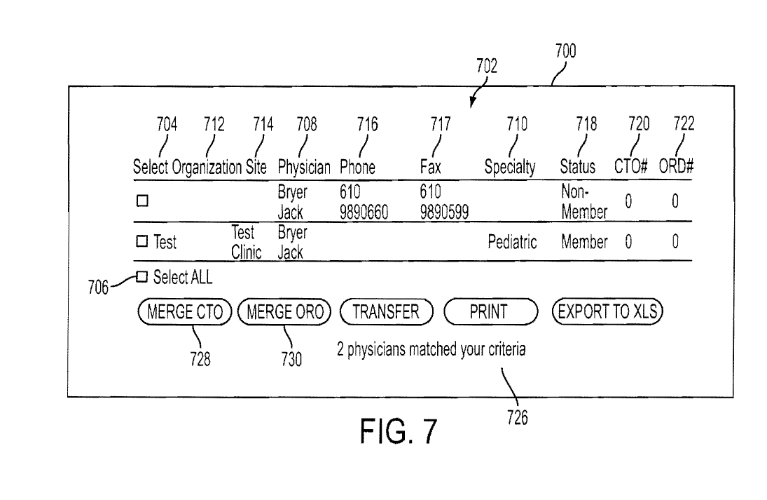

Clicking on the “Find Physicians” button 618 causes the database server 114 to search for physician records matching the search criteria. The database server 114 passes the search results to the Web server 110 which formats them as shown in FIG. 7. The search results page 700 shows the search results in the form of a table 702. At the far left is a select column 704, which allows the user to select individual physicians for further consideration or to select all physicians through a “Select all” check box 706. The name column 708 lists the physicians by name, with links to their profiles in the database. The specialty column 710 gives each physician's specialty. The organization column 712 and the site column 714 identify the organization and site, respectively, with which each physician is associated and include links to those organizations' and sites' profiles. A telephone number column 716 and a facsimile number column 717 give that information for each physician. The membership status column 718 identifies each physician as a member or non-member. The CTO column 720 and the ORO column 722 list CTO's and ORO's, respectively, with which the physician is or has been involved. Columns can be sorted by clicking on the name of the column. An indicator 726 identifies the number of physicians who have matched the query. The merge buttons 728 and 730 allow the user to merge the records for the selected physicians with a CTO or ORO in a manner to be explained below.

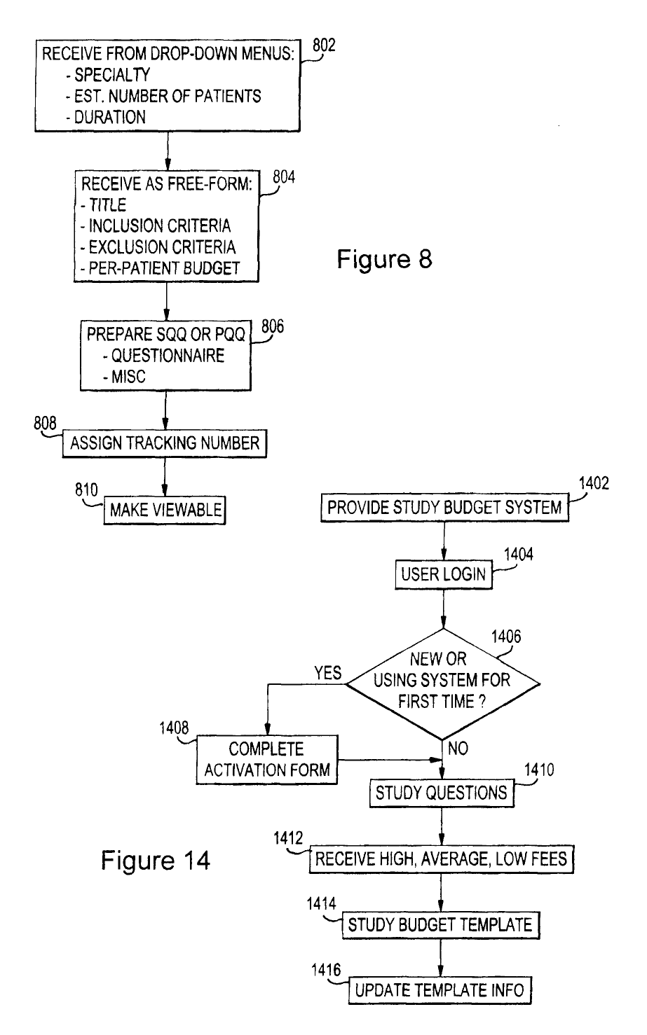

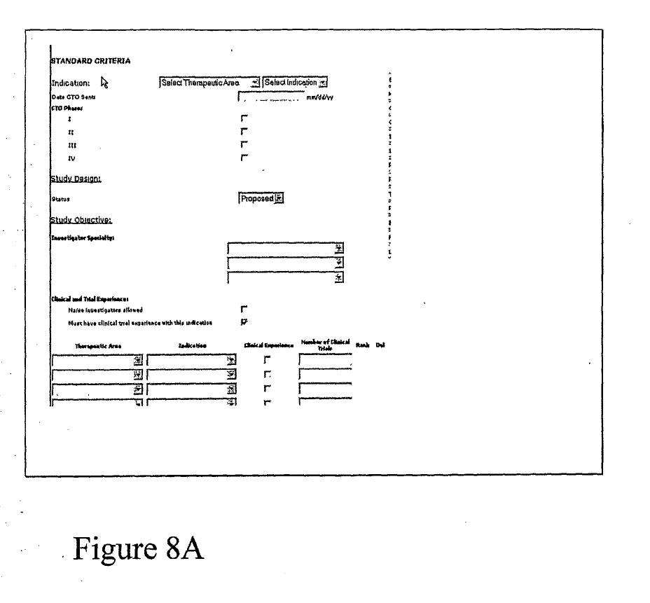

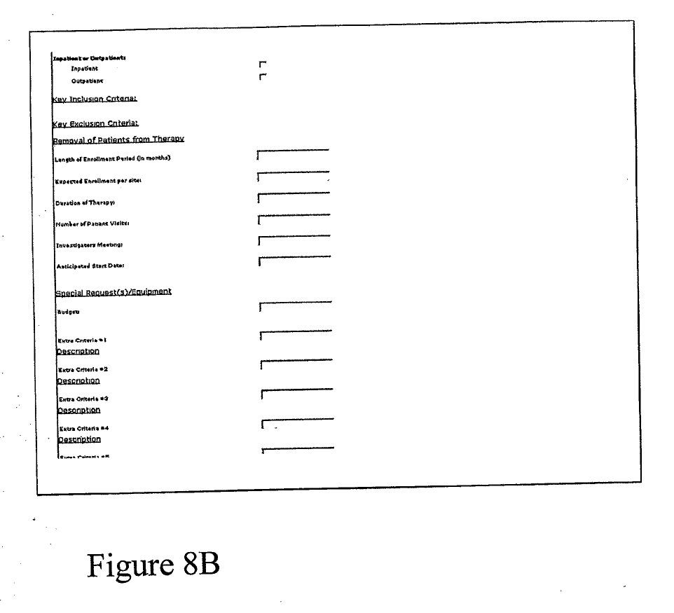

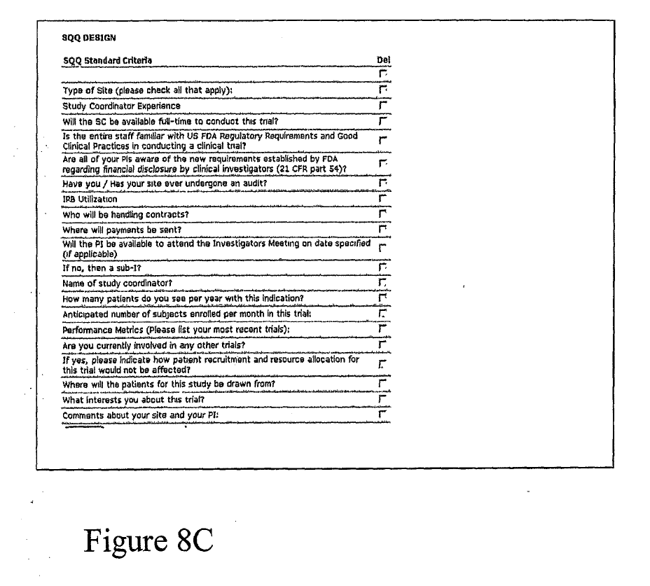

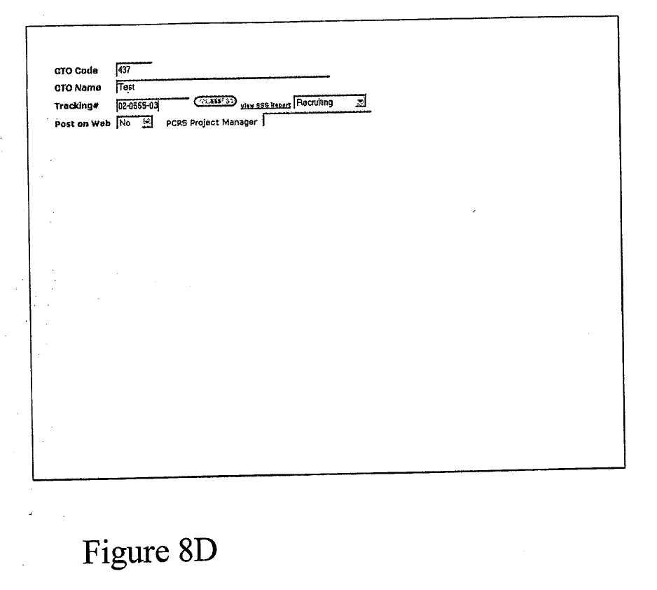

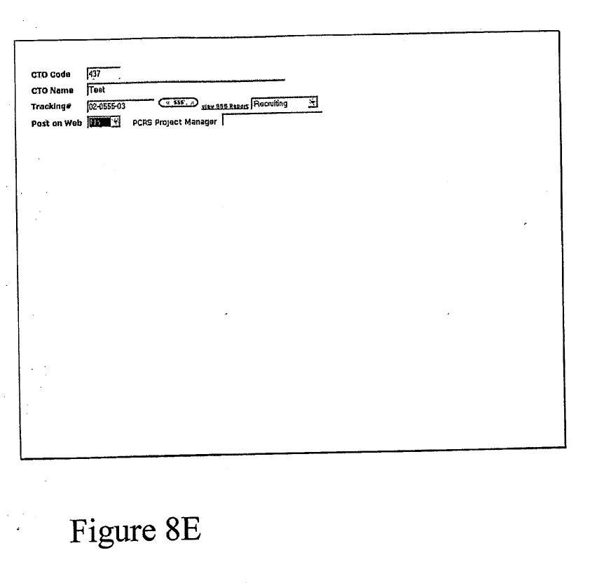

An employee of the service can enter a CTO or ORO as shown in FIG. 8. At step 802, the following are selected through drop-down menus or other suitable interface elements (see FIG. 8A): the specialty concerned (e.g., urology), the estimated number of patients, and the duration. At step 804, the following are input as free-form text (see FIG. 8B): a descriptive title of the study, one or more inclusion criteria for patients (e.g., male patient aged 40-85 years), one or more exclusion criteria for patients (e.g., no previous prostatic surgery within two weeks of base line), and a per-patient budget (this can be indicated as “to be negotiated”). The criteria can also be selected through drop-down menus, in which case there will be an option to add criteria not appearing in the menus. The criteria can also be assigned a sorting order. Through a Design SQQ/PQQ Interface, the relevant SQQ or PQQ is designed and posted on the web at step 806 (see FIG. 8C). A number is manually assigned at step 808 (see FIG. 8D). The opportunity can be made viewable to network members only by an employee of the service at step 810 (see FIG. 8E). The CTO or ORO can be made viewable to persons viewing the organization's or site's profile or in a list sorted by specialty; preferably, both are done.

Once the CTO or ORO is entered, the search results from FIG. 7 can be merged into the CTO or ORO. Once the button 728 or 730 is clicked, the merge page 902 or 904 in the merge area 900 of FIG. 9 appears. The user can select the Merge CTO or Merge ORO 902 or 904 and click the “Merge” button 906 or may cancel by closing the window. If the “Merge” button 906 is clicked, all of the selected search results from FIG. 7 are linked to the description of the CTO or ORO in the database. Checking for duplicate records is done automatically.

The physicians, organizations, or sites merged into the listing can be invited to consider the CTO or ORO. Since anyone found in the search results will have provided some contact information, the invitation can be made by e-mail, facsimile, or any other suitable channel.

Thus, the service (or, in an alternative embodiment, a sponsor of a CTO or ORO) can initiate contact with a physician, organization or site which may be suited to conduct that CTO or ORO, as described above with reference to FIG. 9. Either way, the questionnaire is completed and returned to the sponsor. The sponsor considers the questionnaire and can send a person to interview the physician or otherwise visit the organization or site at which the trial or other research would take place. A Web page can be provided to indicate the reasons why any particular physician, organization or site was accepted or declined. That Web page is accessible only by employees of the service or network members who have registered to use the system.

Once a physician, organization or site is selected to conduct the trial, data are collected for benchmarking. General (industry) benchmarks include the following: revenue per primary investigator per year, patients enrolled per number of coordinator FTE's, average revenue per patient, distribution of revenue by type, average enrollment as a percentage of goal, split of patient recruitment between in-house and advertised, average number of protocols per year, average number of years in clinical research, percentage of studies through third party, percentage of studies directly from CRO or sponsor, number of sponsors with which a particular physician, site or organization has worked, and number of CRO's with which a particular physician, site or organization has worked. Benchmarks specific to a particular study include the following: time to first patient enrolled, total patients enrolled after the first thirty days, actual enrollment as a percentage of the enrollment goal, per-patient budget, number of queries per patient, enrollment as a percentage of total patients screened, and elapsed time from notification of award of study to initiation visit. Data entered into the Web Form (Site Status Summary, or SSS) are used to compute the benchmarks specific to a particular study. Those data are collected on a per-protocol basis, are specific to that protocol and are not stored for future protocols. On the other hand, information collected in the profiles can be used to update the SQQ/PQQ. Examples of Web pages for taking data associated with a particular study are shown in

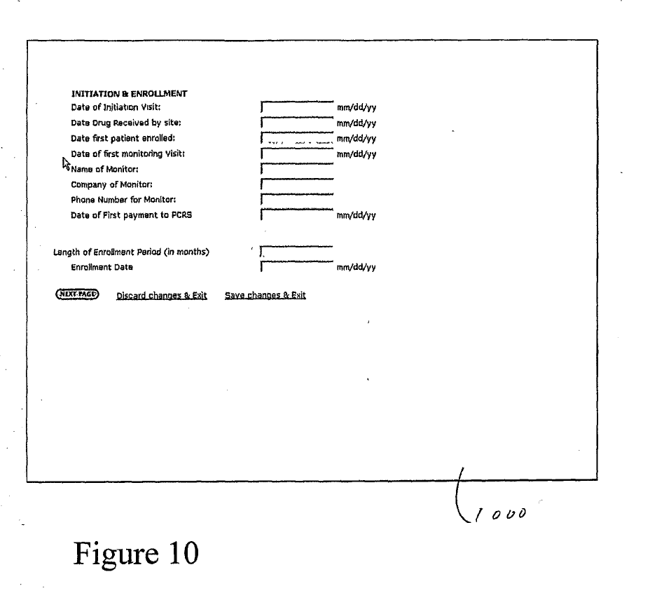

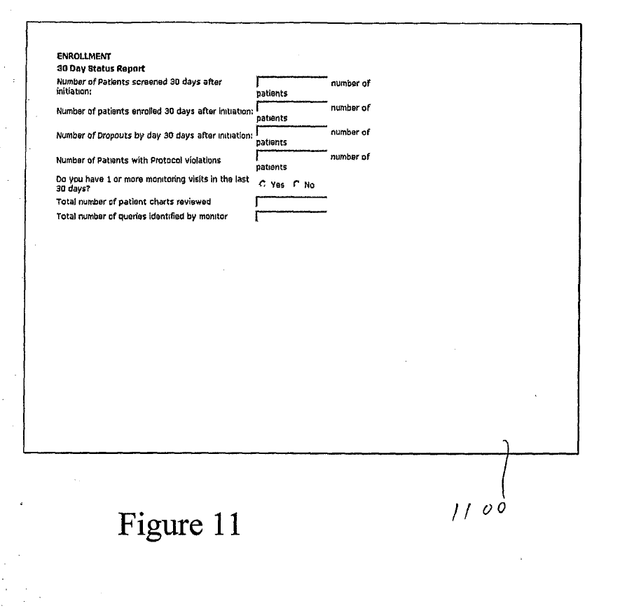

FIGS. 10 and 11 as 1000 and 1100, respectively. The page 1100 is only partially shown, since the data are taken not simply at the end of 30 days, but rather at the end of every 30-day interval until the end of the study; for instance, the page 1100 may ask for the number of patients screened after 720 days, etc. At the end of the study, data may be collected, such as the date of the study close-out visit and the number of queries generated.

The benchmarks are calculated automatically by the system. The more data inputted, the more an organization can access. They do not have to wait until the study is over until they can view benchmarks, but as soon as the relevant data are input the benchmark is viewable. Once all of the data are input and the study is concluded, or once the data currently available are input if benchmarking during the study is required, benchmarking can be performed using straightforward calculations on the data. Two examples of data outputs are shown; those skilled in the art will recognize that many other types of data outputs can be provided as needed.

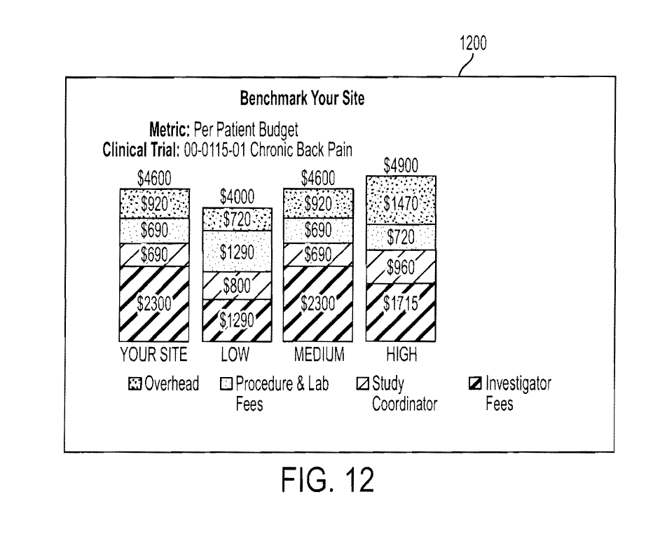

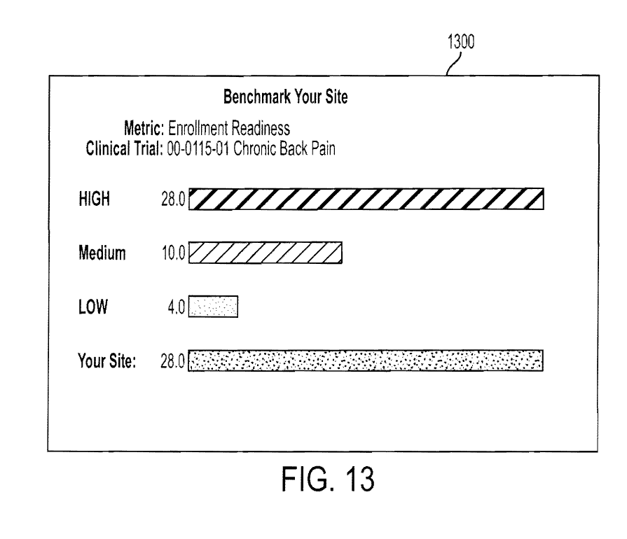

FIG. 12 shows a bar chart 1200 in which the total budget per patient is broken down into overhead, procedure and lab fees, the study coordinator, and the investigator fees. FIG. 13 shows a bar chart 1300 showing a particular benchmark by its value in the user's study compared to its high, low, and average values from among all organizations participating in the same opportunity monitored by the database server 114. The identities of the other organizations are not identified. Each of the bars of the bar chart 1300 can be broken up like the bar in the bar chart 1200.

The benchmarks can be displayed to the sponsor of the study, the physician, site or organization conducting the study, or both. Non-numerical information, such as the identities of the physicians involved in the study and information about them, can also be reported.

An enhancement to the service provides a customizable search page for the “study budget project” where physicians can search for a price range for their service. The search is intuitive enough to allow physicians to select predetermined criteria to focus their search. Physicians will also be able to download their study budget information in a standard template usable in a spreadsheet program (e.g., Microsoft Excel).

At step 1402, a study budget system is provided, which is a separate module from the service previously described. At step 1404, the user logs in. Members will pay a yearly license fee, billed monthly. Existing users will be able to retrieve their user name and password information by entering their e-mail address.

If the system determines at step 1406 that the user is a new user, or is an existing member using the system for the first time, the user will be required to complete an activation form at step 1408. On confirmation of the user's credit card, the user will receive a welcome message and information about their subscription via e-mail.

At step 1410, the user will choose from standard study questions about that user's procedure type, which sets the parameters for the query. At step 1412, the user receives high, average, and low fees for the selected query.

At step 1414, a study budget template is provided in order to be populated with the user's information. The study budget template provides automatic calculations and a printable template. At step 1416, on completion of the template, the information is updated to the database.

While the disclosure set forth above is believed to provide an enabling disclosure of the present invention and a best mode for carrying out the present invention, an administrative-level user's guide will now be set forth for the sake of completeness. For ease of understanding, the user's guide is organized in tabular form.

| Question | Topic | Response |
|---|---|---|
| What happens | New Site | If it is completed on-line, |
| when a site | Applications | E-mail Copy automatically goes to the service. |
| completes their | Completing | The Site Recruiter then logs onto |
| application on- | Reference Check | www.rapidtrials.com/orge.asp |
| line or hard | Information on | They select the organization name from the drop |
| copy? | Rapidtrials | down list and hit EDIT |
| | Activating a New | They move using ALT +N or Next Page to the last |
| | Site | page of the profile |
| | | The last page lists the references |
| | | They also list whether the references were: |
| | | “outstanding” |
| | | “Average” |
| | | “Unfavorable” |
| | | Once the reference checks are done, these are |
| | | changed as appropriate |
| | | The date the contract is signed is inputted into the |
| | | first page, as well as some other contract |
| | | information. |
| | | Once the site is ready to be a member of the |
| | | network the site recruiter goes to the first page of |
| | | the organization profile, by going to |
| | | www.rapidtrials.com/orge.asp, members admin, |
| | | selecting the org name from the drop down and |
| | | hitting EDIT |
| | | Members admin page drop down list of |
| | | organizations If the organization is in black it is an |
| | | active member of the network, if the org is in blue |
| | | or any other color you can check the status by |
| | | going to Edit and looking at the status drop down |
| | | halfway down page one of the organization profile. |
| | | Halfway down the first page is a status drop down. |
| | | The status is: |
| | | Active |
| | | Terminated |
| | | Contact |
| | | Hold |
| | | Pending |
| | | Inactive |
| | | The organization status is changed to Active. This |
| | | automatically creates a second browser window |
| | | with the User ID and Passwords for that |
| | | organization. |
| | | You then select Export to XLS, and these can be |
| | | printed out from XLS and faxed to the |
| | | organization. |
| | | You then close the second browser window and |
| | | select ‘Save changes and Exit’ |
| | | This organization is now an Active member of the |
| | | network and has full access to the member's |
| | | section. |
| How do I put a | Posting a New | The Project manager identifies a new CTO |
| new clinical | Clinical Trial | Log on to Rapidtrials.com |
| trial | Opportunity on | This will take you to CTO Admin or |
| opportunity on | Rapidtrials | www.rapidtrials.com/cto/asp |
| Rapidtrials | Creating a PCRS | Click New |
| | Tracking Number | Enter the CTO name |
| | | Enter the Tracking Number |
| | | Enter if the CTO is recruiting Yes/No (When a |
| | | CTO is no longer recruiting this must be changed to |
| | | No) |
| | | Enter if the CTO is to be shown on the web Yes/No |
| | | (When the CTO is no longer to be viewed on the |
| | | web must be changed to NO) |
| | | Enter Project Manager Name |
| | | Enter which of the following are applicable (to be |
| | | update, as information becomes available over |
| | | time) |
| | | Sponsor |
| | | Sponsor contact Name |
| | | Sponsor Contract Name |
| | | CRO |
| | | CRO contact name |
| | | CRO contract name |
| | | Then select save |
| How do I create | Creating a Synopsis | Click CTO description |
| a CTO Online | for a Clinical Trial | This is where you create the synopsis for the |
| | (CTO) | clinical trial |
| | | For those choices that appear in blue, click on the |
| | | blue link, type in the text that is to appear under |
| | | that link, click save and click return |
| | | Select Therapeutic Area and indication from the |
| | | dropdown |
| | | Date CTO sent to sites |
| | | CTO Phase |
| | | Study design |
| | | Status-Proposed or awarded |
| | | Study Objective |
| | | Investigator specialty, up to three from dropdown |
| | | Clinical Experience, do they have to have |
| | | experience or can they be trial naive |
| | | Is a certain number of past clinical trials necessary, |
| | | indicate this here |
| | | IRB Utilization-Central or Local |
| | | Type of site, check all that apply |
| | | Is it Inpatient/Outpatient? |
| | | Key Inclusion Criteria |
| | | Key exclusion Criteria |
| | | Removal of patients from therapy |
| | | Length in enrollment in months |
| | | Note: This generates the correct amount of 30 day |
| | | increments for the benchmarking |
| | | Expected enrollment |
| | | Duration of therapy |
| | | Number of patient visits |
| | | Investigator Meeting |
| | | Anticipated Start Date |
| | | Special request/equipment |
| | | Budget |
| | | There are then 5 extra criteria, which you can label |
| | | and then enter text for |
| | | Click Save |
| How do I create | Creating an SQQ | Click SQQ design |
| a Site | Using the same | If there is another SQQ already created that you |
| Qualification | template as a | know is identical to the one you wish to create, or |
| Questionnaire | previously | very similar so that you would change just one or |
| (SQQ) Online | developed SQQ | two things- |
| | Creating Custom | Click Load SQQ pattern from another CTO |
| | Questions | Select CTO Name and click OK |
| | | Say OK |
| | | This will create the same SQQ for your clinical trial |
| | | OR |
| | | To create a brand new SQQ |
| | | Click SQQ design |
| | | There will be a list of standard questions, these are |
| | | questions that if they are completed on the profiles |
| | | will pre fill for the Investigators |
| | | Select those you wish to delete |
| | | Note: The one that is blank is actually Board |
| | | Certification |
| | | If you wish to create specialized questions, in |
| | | addition to the standard questions, click Further |
| | | Criteria |
| | | Click Simple Questions |
| | | A Question Interface appears |
| | | Let's use some examples: |
| | | How far away is the nearest airport? |
| | | in miles |
| | | Which of the following apply to your site? Small, |
| | | Medium or Large |
| | | Check all that your site has ECG, Sleep Lab, Study |
| | | Coord |
| | | What date is your next IRB meeting? |
| | | Using the Interface Label- |
| | | 1. Question One |
| | | Label = How far away is your site |
| | | After Label = miles |
| | | Question Type = Text box |
| | | Question Data Type = Text |
| | | Multiple Choices = |
| | | 2. Question Two |
| | | Label = Which of the following |
| | | apply to your site? |
| | | After Label = |
| | | Question Type = Combo Box (only one |
| | | answer allowed) |
| | | Question Data Type = Numeric |
| | | Multiple Choices = Small, Medium, |
| | | Large |
| | | 3. Question Three |
| | | Label = Check all that your site has |
| | | After Label = |
| | | Question Type = Multiple Choices (allows |
| | | for more than one answer) |
| | | Question Data Type = Numeric Multiple Choices = |
| | | ECG, Sleep |
| | | Lab, Study Coord |
| | | 4. Question Four |
| | | Label = What date is your next IRB |
| | | meeting |
| | | After Label = |
| | | Question Type = Text box |
| | | Question Data Type = Date |
| | | Multiple Choices = |
| | | Then Click Save |
| | | This saves your question and it shows up under the |
| | | Criteria Label |
| | | Continue clicking Simple Questions and then |
| | | creating questions until you are done |
| | | To change any question you have already created, |
| | | click the blue link and make your changes and click |
| | | save |
| | | When you are done Click SQQ combination, this |
| | | merges the standard questions and the special |
| | | questions |
| | | Click re number, and then number the questions so |
| | | that they appear in the correct order. |
| | | To delete a question click the delete box then save |
| | | To make further changes to the special questions |
| | | click Edit further criteria and click on the blue links |
| | | and make the change, click save and then SQQ |
| | | combination |
| | | When you are satisfied with the order click Save |
| | | Then click Save Changes and Exit |
| TO send | | |
| automatic | | The project manager will provide with the new |
| emails to the | | CTO a list of specialties who need to be informed |
| orgs to inform | | about this trial |
| them of a new | | From CTO admin, click search, this appears above |
| CTO | | the matched site window |
| | | This will take you to the search page |
| | | Select enable-Membership Status |
| | | The choices are member, non-member, or all |
| | | Select member |
| | | Under Investigator specialty, click enable and |
| | | choose the specialty from the drop down box |
| | | Note; The search by specialty is an AND search, |
| | | not an OR search. So choose only one specialty at a |
| | | time. |
| | | Click Find Physicians |
| | | At the bottom of the search results page, click |
| | | select all |
| | | Review the list and those that you do not wish to |
| | | inform of the clinical trial unselect them by clicking |
| | | on the checkmark on the left-hand side so that the |
| | | box is empty. |
| | | Then click merge CTO |
| | | Select the CTO name |
| | | Click Merge |
| | | This will dump the sites you selected into the |
| | | matched window on the CTO admin page |
| | | Repeat with each specialty until completed |
| | | From CTO admin |
| | | Click Select All next to matched window |
| | | Click Send SQQ and description |
| | | This will create an email and fax list of all the |
| | | matched organizations |
| | | To send the email click send mail all |
| | | One email is sent to each organization contact |
| | | person that you identified, the email lists all the |
| | | suitable investigators at that site. |
| TO add a | | Go to CTO admin |
| doctor that has | | Under CTO name drop down list, select the name |
| submitted for a | | and click Edit |
| clinical trial | | OR |
| | | Enter tracking number on the top bar and click |
| | | EDIT |
| | | IF |
| | | Doctor appears in matched window |
| | | Doctor does not appear in matched window |
| | | 1. Select his name by clicking on it |
| | | Click SSS |
| | | Then click EDIT under Update |
| | | Compete the first page: |
| | | Date of submission deadline |
| | | Date of submission |
| | | Date notified of submission |
| | | Note: This last field sends an automatic email to the |
| | | site when it is completed. See attached email |
| | | Click Save changes and Exit |
| | | His status will now be Submitted pending selection |
| | | 2. From CTO admin halfway down |
| | | Select Org Name |
| | | Select Site |
| | | Select Physician |
| | | Click ADD |
| | | He will go in to the top of the matched window |
| | | Follow above steps |
| To get a list of | | Go to responded window |
| doctors | | Click on first name in the box |
| submitted for a | | Click Shift |
| study (not | | Click on last name in the box |
| including those | | Click Show Info |
| whose status is | | Print report |
| not submitted) | | |
| To remove a | | Click on his name |
| doctor from a | | Click remove |
| trial | | To view info for a doctor |
| | | Click his name |
| | | Click view info |
| | | Info is shown as: Name, Site, Org, Specialty, Tel #, |
| | | Fax #, Status, Last Change |
| To update SSS | | Click his name |
| | | Click SSS |
| | | Click Edit under Update |
| | | To view SQQ |
| | | Click his name |
| | | Click SQQ |
| To add a new | | Click New next to Sponsor |
| Sponsor | | Enter Info |
| | | Click Save |
| | | Click Return |
| | | Same for Sponsor Contact, Sponsor Contract, CRO, |
| | | CRO Contact, and CRO Contract |
| | Search Page | Every criteria you enable limits your search |
| | | It is a wild card to search: |
| | | To search for Bill Jones, enable physician name |
| | | and enter |
| | | Bill |
| | | Jones |
| | | Bi |
| | | Ll |
| | | Jo |
| | | Nes |
| | | Etc |
| | | Click find physicians to get results |
| | | Results are shown as Org, Site, Physician, Phone, |
| | | Fax, Specialty, Status (member/non-member), |
| | | CTO, ORO |
| | | The results can be sorted by any of the column |
| | | headings, simply click on them |
| | | Clicking on the physician's name takes you to his |
| | | profile |
| | | Clicking on the site name takes you to the site |
| | | profile |
| | | Clicking on the org name takes you to the |
| | | organization profile |
| | To transfer a doctor | If a doctor moves from one organization, or more |
| | | likely someone entered him in the wrong |
| | | organization profile |
| | | Search for the physicians |
| | | From the results page select doctor to be transferred |
| | | Member Admin Page |
| | | Organization Level |
| | | To create a new org, click new |
| | | To edit an existing org, select name from drop |
| | | down list and click edit |
| | | Click Transfer |
| | | Select Org and Site he is to be transferred to |
| | | Click Transfer |
| | | To view (in read only mode) an existing org, select |
| | | name from drop down list and click show |
| | | To view the sites for that org, select site name from |
| | | drop down and click site |
| | | Site Level |
| | | To create a new site, click new |
| | | To edit an existing site, select name from drop |
| | | down list and click edit |
| | | To view (in read only mode) an existing site, select |
| | | name from dropdown list and click show |
| | | To view the members for that site, select site name |
| | | from drop down and click members |
| | | To view the SSS for a site (all the trials that they |
| | | are linked with) click SSS |
| | | To delete a site, select the site name from the drop |
| | | down and click delete |
| | | Members Level |
| | | To create a new member, click new |
| | | To edit an existing member, select name from drop |
| | | down lists and click edit |
| | | To view (in read only mode) an existing member, |
| | | select name from dropdown list and click show |
| | | To view the SSS for member (all the trials that they |
| | | are linked with) click SSS |
| | | To delete a member, select the member name from |
| | | the drop down and click delete |
| | | Please Note |
| | | If you change the organization name at the |
| | | organization level, the site level and the member |
| | | level DOES NOT AUTOMATICALLY CHANGE. |
| | | You must click Site and Member again to ensure |
| | | the information you are looking at is relevant to the |
| | | site that you are viewing |
| | | To view the SSS for and org (all the trials that they |
| | | are linked with) click SSS |
| | | To delete an org, select the org name from the drop |
| | | down and click delete |
| SSS Search | | Mini search for CTO Issues |
| Criteria | | Results are always shown as CTO Number, Org |
| | | Name, Site Name, Physician, Specialty, Phone, |
| | | Fax, Sponsor/CRO, Status, Last Change, Access to |
| | | SSS |
| | | You can search by |
| | | Tracking Number |
| | | Organization Name |
| | | Site Name |
| | | Physician Name |
| | | The more information you enter the more limited |
| | | your search |
| | | After you enter the search criteria, click find |
| | | To get to CTO admin, click CTO |
| | | To reset search criteria, click reset |
| | Passwords | Click Passwords Link |
| | | Select the organization that you want to get |
| | | passwords for |
| | | Click Update |
| | | Make changes and to save click update |
| | | To print, click print |
| | | To export to XLS, click export to XLS |
| | Tracking of Web | These are tracked by |
| | Site Changes | SSS changes |
| | | SQQ changes |
| | | Profile changes |
| | | It tracks-Tracking number, Physician, Site, Org, |
| | | Date and Time of change, Location of change |
| | | (form name and page) |
| | Physician History | View which CTO have been sent to a physician and |
| | | whether they responded (yes or no) |
| | | Search by name, site, organization or institution |
| | | (for ORO doctors) |
| | | Limit as much as you want, more info, more |
| | | limited search, another wild card search |
| | | Hit Find |
| | | Then select which physician and click View |
| | | History |
| | | History shown as CTOs offered responded Yes/No |
| | | OROs offered responded Yes/No |
| | Sponsor Requests | |
| | Results of tell us | |
| | about your needs | |
| | Marketer Requests | |
| | Results of See what | |
| | we can do for you | |

Various other enhancements can be made to the present invention. They will now be set forth.

| Functionality | Description |
|---|---|
| Best Practices | Extension of the benchmarking capability, this would be accessible to |
| Across All Sites | members. Based on benchmarking metrics, those sites with the best |
| Benchmarked | practices will be identified by the service, contacted and interviewed on |
| | how they obtained the results in this trial. This information will be shared |
| | confidentially with other sites in the same protocol. This will promote |
| | information exchange amongst sites, help research naive sites, or poorer |
| | performing sites to achieve better results on studies, and identify problems |
| | before a study closeout situation occurs |
| Secure Bulletin | Each clinical trial listed on Rapidtrials and whose status is on-going will |
| Board | have a one (1) way (from the service outboard) Bulletin Board where |
| | sponsors can post information about a study including Q&A type |
| | information In addition, Sponsor project managers can use the bulletin |
| | Board to share information about the study on a on-going basis |
| Rapid Budget | Separate Web Module accessible from the current website (rapidtrials.com). |
| | Members pay a yearly fee, billed monthly. They can apply for membership |
| | via the website (rapidtrials.com), with payment accepted via credit card. A |
| | new user will be required to complete an activation form; this will collect |
| | basic data on the physician and his organization. The module will ask them |
| | questions about the type of study they wish to budget for and which |
| | procedures are involved. Users receive a high, average, low, and your site |
| | (which allows them to view what they charged for the procedure the last |
| | time they used the system). The system then asks them to choose a price for |
| | each procedure, this feeds into a basic per patient clinical trial specific study |
| | budget template which when they have completed choosing their ranges |
| | they can print the complete budget worksheet from the website. This |
| | information then updates the underlying sequel table, so it will be available |
| | to be used in the calculation for the next user. |
| RapidTraining | Current Training Program owned by the service is for Novice Sites and or |
| | as a refresher course for experienced sites. Currently we have the program |
| | on CD and will Migrate the CD based training program to the Web as a |
| | standalone serviced |
| Rapid Meeting | Investigator CD platform currently exists. Will be migrated to the Web. |
| Rapidpatient | This will be a guide Clinical Research sites in selecting strategies and |
| Recruitment | tactics to aid in the clinical trial patient recruitment and retention activities. |
| | Based upon a users description of the patient recruitment and retention |
| | objectives they are attempting to support, the Rapidtrials web module will |
| | suggest appropriate tactics to support the objectives. This module will also |
| | include IRB/FDA regulations governing patient recruitment advertising and |
| | recruitment guidelines. This module of the Rapidtrials website will be a |
| | portal for ordering mugs, t-shirts, ads, media buying, plaques and other |
| | promotional items through the service to enhance patient recruitment and |
| | retention in clinical trials. A catalog of items, which are IRB/FDA |
| | compliant that they can order through us. |
| Rapid Assessment | A Rapidtrials web module that uses a psycho-behavioral assessment |
| | (similar to Myers Briggs) that has been validated by the service using |
| | historical performance and behavioral assessment response correlation's to |
| | identify sites with a high probability of succeeding in clinical trials. |
| | Investigators and coordinators will complete this behavioral assessment on- |
| | line as a predictive tool for the practice of future success in clinical trials. |
| | Gaps in attributes will be identified for Sites as a means of guiding them in |
| | clinical research program recruitment. For sponsors involved in site |
| | selection, or preparing to invest in site development it will give them |
| | another performance indicator prior to selecting sites to participate in a |
| | clinical trial. |
| Industry | Generated by data entered into members organization, site and Investigator |
| Benchmarking | profiles, these benchmarks will be displayed by Type of Organization (I.e. |
| | solo practice, SMO etc): Total number of protocols per year, Total grant |
| | value per protocol, total number of patients enrolled in a clinical trial/year, |
| | total number of Study coordinators, total number of sites doing research, |
| | Total number of Patients per study coordinator FTE's, Average number of |
| | Patients per year, Number of Physicians, Number of PI's, Overhead as a |
| | percentage of total per patient budget, Study Coordinator costs as a |
| | percentage of Total per patient budget, Investigator Fees as a percentage of |
| | total per patient budget, Procedure, lab fees as a percentage of total per |
| | patient budget, total number of sponsors worked for/year, Total number of |
| | CROs/year, Actual Enrollment/Enrollment |
| | Goal. |
| Site Capabilities | Data capture approved by field based consultants to gather information on |
| Assessment Data | sites developing research programs or preparing to participate in clinical |
| Capture and | trial. Migration of proprietary data capture tools to the web. |
| Reporting | |
| Site Operations | Data capture pages used by field based consultants to gather information on |
| Specialists Site | sites developing research programs or preparing to participate in clinical |
| Development | trial. Migration of proprietary data capture tools to the web. This is the |
| eWorkbook | same as the above. |
| Site Operations | Data Capture Pages, tools and presentations to use in preparing for and |
| Specialists Site | monitoring site performance on a clinical trial. Migration of Proprietary |
| Management | Data Capture tools to the web |
| eWorkbook | |

While a preferred embodiment of the present invention has been set forth in detail, those skilled in the art who have reviewed the present disclosure will readily appreciate that other embodiments can be realized within the scope of the present invention. For example, the utility of the invention is not limited to the medical field. Also, any benchmarks can be calculated, in which case the forms for collecting the data are modified accordingly. Further, the benchmarks can be displayed as text, as any suitable chart, or as a combination of the two. In addition, either the Web server or the database server can incorporate the ability to handle payments from one participant to another, as well as from participants to the company operating the servers. Moreover, any mention of a specific software package (e.g., Microsoft Excel) should be construed as illustrative rather than limiting. Therefore, the present invention should be construed as limited only by the appended claims.

What is claimed is:

1. A system, comprising:
a database including fees charged for performing procedures associated with clinical trials;
a user interface enabling a user to identify a plurality of procedures included in a clinical trial; and
a server configured to determine information regarding the fees charged for performing each of the plurality of procedures included in the clinical trial and output the information to the user via the user interface.

2. The system of claim 1, wherein the information regarding the fees output to the user includes an average of the fees stored in the database for performing each of the plurality of procedures included in the clinical trial.

3. The system of claim 1, wherein the information regarding the fees output to the user includes the largest fee and the smallest fee stored in the database for performing each of the plurality of procedures included in the clinical trial.

4. The system of claim 1, wherein the information regarding the fees output to the user includes a fee for performing at least one of the plurality of procedures included in the clinical trial in a specific geographic location.

5. The system of claim 1, wherein the server is further configured to update the database to include updated data regarding fees charged for performing procedures associated with clinical trials and to determine and output the information regarding the fees charged for performing each of the plurality of procedures included in the clinical trial based on the updated data.

6. The system of claim 1, wherein the user interface further enables the user to input a desired fee for performing each of the plurality of procedures included in the clinical trial and the server is configured to determine a budget for the clinical trial based at least in part on the plurality of procedures included in the clinical trial and the desired fee input by the user for performing each of the plurality of procedures.

7. The system of claim 6, wherein the budget further includes overhead.

8. The system of claim 6, wherein in the budget includes revenue per patient.

9. The system of claim 6, wherein in server is further configured to output the budget to the user via the user interface.

10. The system of claim 1, wherein the server is a web server and the user interface is a website accessible via the Internet.

11. A method, comprising:
storing, in a database, fees charged for performing procedures associated with clinical trials;
enabling a user to identify a plurality of procedures included in a clinical trial via a user interface;
determining, by a server, information regarding the fees charged for performing each of the plurality of procedures included in the clinical trial; and
outputting the information to the user via the user interface.

12. The method of claim 11, wherein the information regarding the fees output to the user includes an average of the fees stored in the database for performing each of the plurality of procedures included in the clinical trial.

13. The method of claim 11, wherein the information regarding the fees output to the user includes the largest fee and the smallest fee stored in the database for performing each of the plurality of procedures included in the clinical trial.

14. The method of claim 11, wherein the information regarding the fees output to the user includes a fee for performing at least one of the plurality of procedures included in the clinical trial in a specific geographic location.

15. The method of claim 11, further comprising:
updating the database to include updated data regarding fees charged for performing procedures associated with clinical trials,
wherein determining the information regarding the fees charged for performing each of the plurality of procedures included in the clinical trial comprises determining the information based on the updated data.

16. The method of claim 11, further comprising:
enabling the user to input a desired fee for performing each of the plurality of procedures included in the clinical trial; and
determining a budget for the clinical trial based at least in part on the plurality of procedures included in the clinical trial and the desired fee for performing each of the plurality of procedures.

17. The method of claim 16, wherein the budget further includes overhead.

18. The method of claim 16, wherein in the budget includes revenue per patient.

19. The method of claim 16, further comprising:
outputting the budget to the user via the user interface.

20. The method of claim 11, wherein the server is a web server and the user interface is a website accessible via the Internet.

21. A method, comprising:
storing, in a database, fees charged for performing procedures associated with clinical trials;
enabling a user to identify a plurality of procedures included in a clinical trial via a user interface;
determining information regarding the fees charged for performing each of the plurality of procedures included in the clinical trial, the information including the highest fee, the lowest fee, and an average of the fees stored in the database for each of the for performing each of the plurality of procedures included in the clinical trial;
outputting the information to the user via the user interface;
enabling the user to input a desired fee for performing each of the plurality of procedures included in the clinical trial via the user interface;
determining a budget for the clinical trial based at least in part on the plurality of procedures included in the clinical trial and the desired fee for performing each of the plurality of procedures; and
outputting the budget to the user via the user interface.
